(19) United States
(12) Patent Application Publication
(10) Pub. No.: US 2016/0101770 A1
(43) Pub. Date: Apr. 14, 2016

(54) Methods and Systems of Controlling A Vehicle Powertrain

(71) Applicant: Ford Global Technologies, LLC, Dearborn, MI (US)

(72) Inventors: Mark Steven Yamazaki, Canton, MI (US); Bernard D. Nefcy, Novi, MI (US); David Farrell, Dearborn, MI (US); Xiaoyong Wang, Novi, MI (US)

(21) Appl. No.: 14/511,504

(22) Filed: Oct. 10, 2014

(51) Int. Cl. B60W 20/00

(52) U.S. Cl. CPC B60W 20/00

(57) ABSTRACT

A vehicle may include a controller programmed to, in response to a vehicle speed less than a speed threshold, a decrease in driver demand, and a change in steering position greater than a position threshold, maintain a friction element pressure of a friction element configured to couple an engine with and electric machine, and increase an amount of spark retard associated with an engine cylinder.

### TECHNICAL FIELD

This patent application relates to control of vehicle powertrains.

### BACKGROUND

A hybrid electric vehicle (HEV) may be provided with an internal combustion engine and an electric machine in communication with a high voltage battery. Either or both the internal combustion engine and the electric machine are capable of generating power and torque to propel the HEV. The electric machine may provide torque to propel the vehicle in situations in which the driver releases the accelerator pedal.

### SUMMARY

A vehicle may include a powertrain having an engine selectively mechanically coupled via a friction element to an electric machine, and a controller. The controller may be programmed to, while operating the powertrain in a hybrid mode and in response to a steering angle greater than a threshold and a decrease in accelerator pedal position, maintain the engine coupling via the friction element to the electric machine and reduce fuel delivery to the engine.

A vehicle may include a controller. The controller may be programmed to, in response to a vehicle speed less than a speed threshold, a decrease in driver demand, and a change in steering position greater than a position threshold, maintain a friction element pressure of a friction element configured to couple an engine with an electric machine, and increase an amount of spark retard associated with an engine cylinder.

A method of controlling a vehicle powertrain may include, in response to a decrease in accelerator pedal position and a change in steering angle greater than a steering angle threshold while a vehicle speed is less than a speed threshold, deactivating an engine such that an engine crankshaft is capable of rotation and maintaining a friction element pressure such that the engine remains operatively connected to a remainder of the powertrain.

### BRIEF DESCRIPTION OF THE DRAWINGS

FIG. 1 is a schematic diagram of a vehicle.

FIGS. 2A-2D are time plots of an exemplary system response.

FIG. 3 is a flowchart corresponding to a method of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

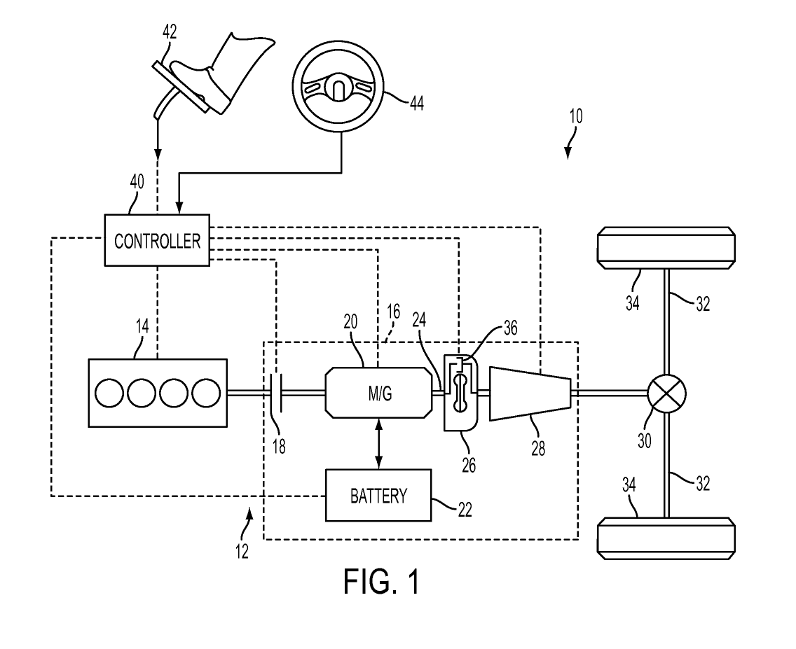

Referring to FIG. 1, a schematic diagram of a vehicle 10 is illustrated according to an embodiment of the present disclosure. Physical placement and orientation of the components within the vehicle 10 may vary. Although the vehicle of FIG. 1 will be particularly described, the strategies in accordance with embodiments of the present disclosure may apply to other vehicle configurations.

The vehicle 10 may include a powertrain 12 having an engine 14 that is operatively connected to a transmission 16. The transmission 16 may include a disconnect clutch 18, an electric machine 20 such as an electric motor-generator, an associated traction battery 22, an input shaft 24, a launch clutch or torque converter 26, and a gear box 28.

The transmission 16 may be configured as a step-ratio transmission using multiple friction elements for transmission gear ratio changes. The transmission 16 may be configured to produce multiple forward and reverse gears via multiple gearing elements within the gear box 28.

The electric machine 20 may be implemented by any one of a plurality of types of electric machines. For example, the electric machine 20 may be a permanent magnet synchronous motor. Power electronics (not shown) may condition a direct current (DC) provided by the traction battery 22 to the requirements of the electric machine 20. The power electronics may provide a three phase alternating current (AC) to the electric machine 20.

The torque converter 26 may be positioned between the electric machine 20 and the gear box 28. The torque converter 26 may be connected to the engine 14 when the disconnect clutch 18 is at least partially engaged. The torque converter 26 may provide a hydraulic coupling between the electric machine shaft and a transmission input shaft. The torque converter 26 may provide torque multiplication during launch events. The torque converter 26 may also perform torsional isolation to the driveline such that the driveline is isolated from disturbances.

The torque converter 26 may include an impeller fixed to an electric machine shaft and a turbine fixed to the transmission input shaft. An internal bypass clutch may also be provided with the torque converter 26 such that, when engaged, the internal bypass clutch frictionally or mechanically couples the impeller and the turbine of the torque converter 26, permitting more efficient power transfer. The torque converter 26 and the internal bypass clutch may be replaced by a launch clutch to control vehicle launch. In contrast when the internal bypass clutch is disengaged, the electric machine 20 may be mechanically decoupled from the remainder of the powertrain 12, including the differential 30, the vehicle axles 32, and vehicle wheels 34. For example during deceleration, the bypass clutch 36 may disengage at low vehicle speeds, decoupling the engine from the transmission and driveline, to allow the engine to idle and operate at low vehicle speeds or stop.

The engine 14 may be selectively coupled to the electric machine 20 by the disconnect clutch 18 such that both are capable of providing motive power for the vehicle 10. The engine 14 and the electric machine 20 may both provide torque to the gearbox 28 via an input shaft 24. The engine 14 may generate power and a corresponding torque that may be supplied to the electric machine 20 when the disconnect clutch 18 is at least partially engaged.

The controller 40 may operate the vehicle 10 in a hybrid mode or charge sustaining mode where the disconnect clutch 18 is at least partially engaged. While operating the vehicle 10 in the charge sustaining mode, the disconnect clutch 18 may be at least partially engaged to operatively couple the engine 14 with the remainder of the powertrain 12. Power flow from the engine 14 to the electric machine 20 or from the electric machine 20 to the engine 14 may be possible. For example, when the disconnect clutch 18 is engaged, the electric machine 20 may operate as a generator to convert rotational energy provided by an engine crankshaft operatively connected to electric machine 20 into electrical energy to be stored by the traction battery 22.

The controller 40 may operate the vehicle 10 in an electric mode or a charge depletion mode. While operating the vehicle 10 in the charge depletion mode, the disconnect clutch 18 may operatively decouple the engine 14 from the remainder of the powertrain 12. The electric machine 20 may operate as the sole drive source for the vehicle 10. The engine 14 may be isolated from the remainder of the powertrain 12 via the disconnect clutch 18. In the charge depletion mode, the traction battery 22 may act as the sole drive source for the vehicle 10.

The controller 40 that may dictate the various operation modes of the vehicle 10 or powertrain 12 may be a single controller. In at least one embodiment, the controller 40 may be part of a larger control system and may be controlled by various other controllers throughout the vehicle 10, such as a vehicle system controller (VSC). It should therefore be understood that the controller 40 and one or more other controllers may collectively be referred to as a “controller” that controls various actuators in response to signals from various sensors to control functions such as starting/stopping the engine 14, stroking/de-stroking the disconnect clutch 18, operating the electric machine 20 to provide wheel torque or charge the traction battery 22, selecting or scheduling transmission shifts, etc.

For example, the controller 40 may receive data from, and issue commands to a transmission control module, that may be in direct communication with components of the transmission 16. Examples of other subservient controllers that may operate lower in a controller hierarchy compared to the controller 40 may include a brake system control module, a high voltage battery energy control module, as well as other controllers which are responsible for various vehicle functions. The controller 40 may further operate to verify data received from other controllers.

The controller 40 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 40 in controlling the powertrain 12 or vehicle 10.

The controller 40 and other controllers may communicate with various engine/vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. The controller 40 may communicate with other vehicle controllers as discussed above, or directly with vehicle sensor and/or components including the engine 14, the transmission 16, the disconnect clutch 18, the electric machine 20, the driveline, the power electronics, and the braking system.

Although not explicitly illustrated, those of ordinary skill in the art may recognize that the controller 40 may be directly or indirectly actuate various parameters, systems, and/or components. The various parameters, systems, and/or components may include fuel injection timing, rate, and duration, throttle valve position, spark plug ignition timing (for spark-ignition engines), intake/exhaust valve timing and duration, timing of an engine camshaft, front-end accessory drive (FEAD) components such as an alternator, air conditioning compressor, battery charging, regenerative braking, M/G or electric machine operation, clutch element pressures for the disconnect clutch 18, torque converter by-pass clutch, torque converter 26, gear box 28, accelerator pedal 42, steering angle sensor of the steering wheel 44 and the like.

Sensors communicating input through the I/O interface may be used to indicate turbocharger boost pressure, turbocharger rotation speed, crankshaft position, camshaft position, engine rotational speed (RPM), wheel speeds, vehicle speed, engine coolant temperature, intake manifold pressure, accelerator pedal position, steering angle position, ignition switch position, throttle valve position, air temperature, exhaust gas oxygen or other exhaust gas component concentration or presence, intake air flow, transmission gear, transmission ratio, or transmission mode, transmission oil temperature, transmission turbine speed, torque converter bypass clutch status, deceleration, or shift mode, for example.

The controller 40 may interpret inputs provided by the driver to the accelerator pedal 42 as a demanded torque, demanded power, or drive command to propel the vehicle 10. In general, depressing and releasing the accelerator pedal 42 may generate an accelerator pedal position signal that may be interpreted by the controller 40 as a demand for increased power or decreased power, respectively. Based at least upon input from the accelerator pedal 42, the controller 40 may allocate torque commands between each of the engine 14 and/or the electric machine 20 to operate the powertrain 12 to satisfy the vehicle torque output demanded by the driver.

The controller 40 may be provided with an accelerator pedal calibration table. The accelerator pedal calibration table may provide correlations between an accelerator pedal position, vehicle speed, and a powertrain torque or power. The controller 40 may interpret the current accelerator pedal position, and based on the vehicle speed, provide a demand for torque or power from the powertrain 12.

The controller 40 may control the timing of gear shifts within the gearbox 28, as well as engagement or disengagement of the disconnect clutch 18 and the torque converter bypass clutch, responsive to inputs provided to the accelerator pedal 42. The torque converter bypass clutch may be modulated across a range between the engaged and disengaged positions. This may produce a variable slip in the torque converter 26 in addition to the variable slip produced by the hydrodynamic coupling between the impeller and the turbine. Alternatively, the torque converter bypass clutch may be operated as either locked or open without using a modulated operating mode depending on the particular application.

The driver of the vehicle 10 may provide input at the steering wheel 44 which may be associated with a steering assembly configured to steer the vehicle 10. Input provided at the steering wheel 44 may be received by a steering angle sensor that may generate a steering angle signal. The steering angle signal may be interpreted by the controller 40 as a demand to the steering assembly to articulate or rotate at least one vehicle wheel an amount proportional to the steering angle signal or the amount of rotation of the steering wheel 44.

In certain circumstances, the engine 14 may be disconnected from the remainder of the powertrain 12 by a friction element associated with the disconnect clutch 18 and the engine 14 shutdown. The engine 14 may be disconnected and shutdown when the driver releases or tips-out the accelerator pedal 42. The disconnect clutch 18 may be de-pressurized and de-stroked.

The release of the accelerator pedal 42 may decrease the accelerator pedal position and the demanded torque or power from the powertrain 12. Should the electric machine 20 is able to satisfy the demanded powertrain torque or power associated with the decreased accelerator pedal position, the powertrain 12 may be operated in electric mode. While operating the powertrain 12 in electric mode, the engine 14 may be disconnected from the electric machine 20, and the engine 14 may be shutdown. If the decrease in demand torque or power from the powertrain 12 is greater than a threshold, the engine 14 may not be shutdown and may remain connected to the remainder of the powertrain 12.

As the vehicle 10 approaches or is within a turn, approaches a freeway or highway entrance, approaches a yield or other traffic signal, a driver of the vehicle 10 may release the accelerator pedal 42 and shortly thereafter depress the accelerator pedal 42. Such events may be referred to as change of mind events. Upon the driver depressing the accelerator pedal 42 which may increase the accelerator pedal position, the controller 40 may command an engine start to satisfy the increase in accelerator pedal position.

The engine shutdown and restart procedure may introduce considerable time lag in the delivery of torque or power to satisfy the driver expectations due to the transition from electric mode to hybrid mode. The time lag may result from the re-pressurization of a friction element of the disconnect clutch 18 and the spinning of the engine 14, via the electric machine 20, to start the engine 14 and reach the synchronous speed so that the engine 14 may transmit propulsive torque. This time lag may produce a driveline disturbance and/or a shortfall in torque delivery (torque hole) for the duration of the engine start, which may be disagreeable to the driver of the vehicle 10.

The controller 40 may be provided with control logic configured to control engine 14 or powertrain 12 operation during change of mind events. The controller 40 may be programmed to receive inputs from the accelerator pedal 42 and the steering wheel 44, and based on the vehicle speed, control the operation of the powertrain 12.

The controller 40 may be programmed to, while operating the powertrain 12 in hybrid mode and in response to a vehicle speed less than a threshold vehicle speed, a steering angle greater than a threshold steering angle, and a decrease in accelerator pedal position, to operate the powertrain 12 in Decel Fuel Shut Off (DFSO) mode. The controller 40 may be further programmed to maintain the powertrain 12 in a state that may permit a faster resumption of torque production as compared to the above mentioned method.

The vehicle speed less than a threshold vehicle speed and the steering angle greater than a steering angle threshold may indicate that the vehicle 10 is entering or has entered a turn. The steering angle threshold may be a band centered about a nominal steering position or zero degrees. A steering wheel position greater than the band may indicate that the vehicle 10 is turning.

The controller 40 may further determine when to operate the powertrain 12 in DFSO mode based on a current vehicle speed and a current transmission ratio. The current vehicle speed and the current transmission ratio may be used by the controller 40 to determine the amount of torque or power that may be provided by the electric machine 20 if and when the engine 14 is partially shutdown such that the electric machine 20 may propel the vehicle 10.

Operation of the powertrain 12 in DFSO mode may result in a partial engine shutdown and the engine 14 remaining operatively coupled with the remainder of the powertrain 12. The controller 40 may command a reduction in an amount of fuel delivered to an engine cylinder associated with the engine 14. The controller 40 may command an increase in an amount of spark retard associated with an engine cylinder associated with the engine 14. The amount of spark retard associated with an engine cylinder may be based on a current vehicle speed and a current transmission ratio or gear ratio.

The controller 40 may command an adjustment in the timing of an engine camshaft such that any possible engine braking may be inhibited. The controller 40 may command modulation of at least one of an engine intake valve and an engine exhaust valve associated with an engine cylinder. The adjustment in the timing of the engine camshaft or the modulation of the intake valve and/or the exhaust valve may inhibit or reduce the amount of engine braking introduced or amount of powertrain torque removed while the powertrain 12 is operated in DFSO mode. The controller 40 may be further configured to calibrate the modulation of the intake valve and/or the exhaust valve.

The controller 40 may command that a friction element associated with the disconnect clutch 18 remain pressurized to maintain a coupling between the engine 14 and the electric machine 20 or the remainder of the powertrain 12. In at least one embodiment, the torque carrying capacity of the friction element may be reduced while the mechanical coupling between the engine 14 and the electric machine 20 is maintained. The reduction in torque carrying capacity of the friction element may be reduced by reducing a pressure supplied to the friction element while still maintaining at least a nominal pressure to maintain the coupling between the engine 14 and the remainder of the powertrain 12.

The operation of the engine 14 in DFSO mode may attempt to increase vehicle fuel efficiency during vehicle deceleration events. The engine crankshaft may be permitted to rotate due to the operative connection between the engine 14 and the vehicle driveline. The inertia of the vehicle driveline may keep the engine 14 rotating, meaning that the engine 14 may be driven by the road.

The electric machine 20 may continue to operate while the powertrain 12 is operated in DFSO mode. Responsive to a transmission input speed less than a threshold, the controller 40 may command that the electric machine 20 operate to assist in rotating the engine 14. Responsive to a transmission line pressure less than a threshold, the controller 40 may command that the electric machine 20 operate to spin a transmission pump operatively connected to the electric machine 20. The spinning of the transmission pump may maintain or boost the transmission line pressure to at least maintain the current transmission ratio or state.

The driver of the vehicle 10 may depress the accelerator pedal 42 in an attempt to increase vehicle speed. Responsive to an increase in accelerator pedal position, the controller 40 may determine if an engine start is required to satisfy a powertrain demand associated with the current accelerator pedal position.

The controller 40 may command an increase in an amount of fuel delivered to an engine cylinder associated with the engine 14 in response to the engine start request. The controller 40 may decrease an amount of spark retard associated with an engine cylinder associated with the engine 14. The controller 40 may command an adjustment in timing of the engine camshaft and may command an end to the modulation of at least one of the engine intake valve and the engine exhaust valve associated with an engine cylinder. The adjustment and end of modulation may prepare the engine 14 for torque production upon resumption of fueling.

The controller 40 may further command operation of the powertrain 12 to satisfy the increase in accelerator pedal position. The controller 40 may operate at least one of the engine 14 and the electric machine 20.

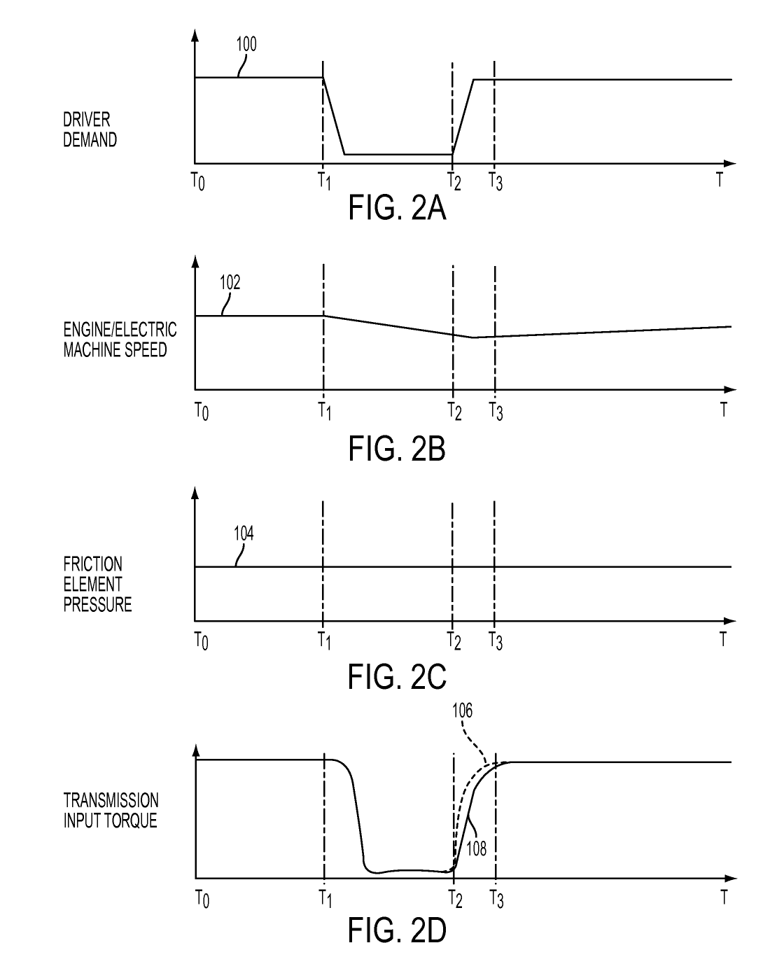

FIGS. 2A through 2D are corresponding time plots of powertrain operating parameters according to the present disclosure. FIG. 2A depicts the driver demand 100 associated with the accelerator pedal position versus time. The driver demand 100 proximate time t0 may remain constant due to the driver maintaining a fairly steady accelerator pedal position. Proximate time t1, the driver may release the accelerator pedal 42. The release of the accelerator pedal 42 may decrease the driver demand 100. The driver may maintain the decreased accelerator pedal position until proximate time t2. Proximate time t2 the driver may depress the accelerator pedal 42 which may increase the driver demand 100.

Proximate time t2 the controller 40 may request that an engine start occur to satisfy the increase in driver demand 100. Proximate time t3, the driver demand 100 may become constant and the powertrain 12 may be operated to satisfy the increased driver demand 100.

FIG. 2B depicts engine and electric machine speed 102 versus time. While operating the engine 14 in DFSO mode, the engine 14 may remain coupled to the electric machine 20 and may spin together. Proximate time t1, the enablement basics to operate the powertrain 12 in DFSO may be satisfied and the controller 40 may operate the powertrain 12 in DFSO mode. The engine and electric machine speed 102 may begin to decrease proportional to the change in accelerator pedal position.

Proximate time t3, the engine and electric machine speed 102 may begin to increase responsive to the increase in driver demand 100 and the engine start resulting in the engine 14 producing torque. The engine and electric machine speed 102 may continue to increase as the powertrain 12 is operated to satisfy the increased driver demand.

FIG. 2C depicts a friction element pressure 104 of the disconnect clutch versus time. The friction element pressure 104 may remain approximately constant throughout time t0 through time t3, while the engine 14 is operating in DFSO mode and transitioning out of DFSO mode.

FIG. 2D depicts a demanded transmission input torque 106 and a delivered transmission input torque 108 versus time. The delivered transmission input torque 108 may be the torque applied to the input shaft 24 by at least one of the engine 14 and the electric machine 20 or a combination of both. The demanded transmission input torque 106 and the delivered transmission input torque 108 may be approximately equal and constant proximate time t0 as through time t1 as the driver demand 100 remains substantially constant.

Proximate time t1, the demanded transmission input torque 106 and the delivered transmission input torque 108 may begin to decrease substantially simultaneously, responsive to the decrease in driver demand 100 as a result of the release of the accelerator pedal 42. As the driver demand 100 becomes approximately constant at decreased level, proximate time t0, the demanded transmission input torque 106 and the delivered transmission input torque 108 may become approximately constant at a decreased level.

Proximate time t2, the demanded transmission input torque 106 may begin to increase responsive to the increase in the driver demand 100. The electric machine 20 may be operated to provide increased torque to the input shaft 24 and the delivered transmission input torque 108 may begin to increase. As the engine 14 begins to start and ultimately produce torque, the delivered transmission input torque 108 may increase. Proximate time t3, a combination of at least one of the engine 14 and the electric machine 20 may be operated such that the delivered transmission input torque 108 satisfies the demanded transmission input torque 106.

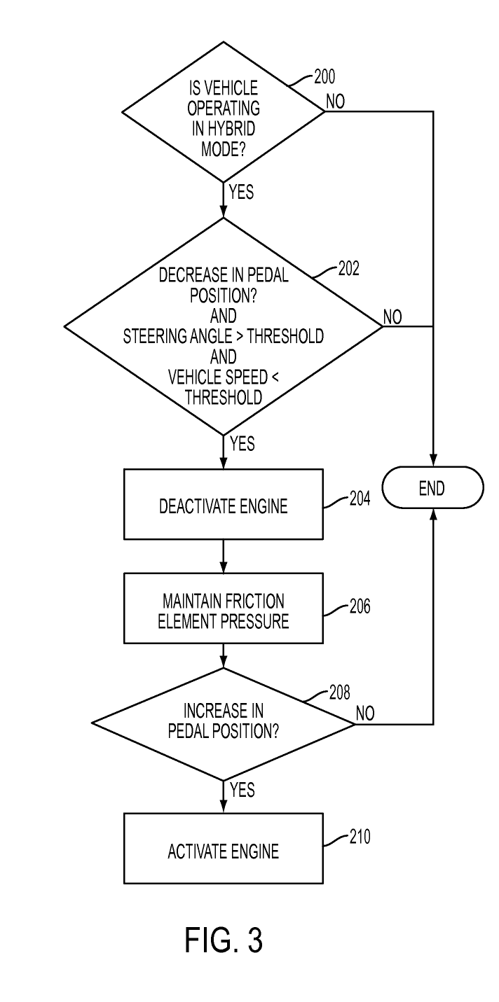

FIG. 3 is a flowchart of a method of controlling a vehicle powertrain. The method may be implemented by the controller 40 based on various inputs received by the controller 40. At block 200, the method may determine if the vehicle 10 or powertrain 12 is operating in hybrid mode. Should the vehicle 10 or powertrain 12 not be operating in hybrid mode, the method may end. If the vehicle 10 or powertrain 12 is operating in hybrid mode, the method may continue to block 202.

At block 202, the method may determine if various enablement basics have been met. The enablement basics may include whether there has been a decrease in accelerator pedal position. The enablement basics may further include whether the steering angle or steering position is greater than a steering threshold angle or threshold position. The enablement basics may still further include whether the vehicle speed is less than a vehicle threshold speed. Should neither enablement basic nor a combination of at least two of the enablement basics be satisfied, the method may end. If the enablement basics or a combination of at least two of the enablement basics are met, the method may operate the powertrain 12 in DFSO mode. The method may continue to block 204.

At block 204, the method may deactivate the engine 14. The engine 14 may be deactivated such that the engine crankshaft may continue to rotate. Deactivating the engine 14 may comprise reducing an amount of fuel delivered to an engine cylinder by a fuel system. Deactivating the engine 14 may comprise increasing an amount of spark retard associated with the engine cylinder.

At block 206, the method may maintain a friction element pressure. The friction element pressure may be maintained such that the engine 14 may remain operatively coupled to the remainder of the powertrain 12. In at least one embodiment, the friction element torque carrying capacity may be reduced by an adjustment of the friction element pressure.

The method may await a change in the accelerator pedal position while it maintains the operative coupling between the engine 14 and the remainder of the powertrain 12, and operates the engine 14 in DFSO mode.

At block 208, the method may determine if there has been an increase in accelerator pedal position. Should an increase in accelerator pedal position not occur, the method may continue to operate the powertrain 12 in DFSO mode or may end. In response to the increase in accelerator pedal position, the method may activate the engine 14 at block 210.

At block 210, the method may end operation of the engine 14 in DFSO mode and activate the engine 14. Activating the engine 14 may comprise increasing an amount of fuel delivered to an engine cylinder by the fuel system. Activating the engine 14 may comprise decreasing an amount of spark retard associated with an engine cylinder. Upon activating the engine 14, the powertrain 12 may be operated to satisfy the increased accelerator pedal position.

Various embodiments of the present disclosure may include associated advantages. For example, the control logic may select an appropriate powertrain operating mode for change of mind events. When it is determined that the vehicle is turning and the accelerator pedal is released, the powertrain may be maintained in a state that permits a fast resumption of torque production to the driveline to meet a driver's demand for torque or power with minimal hesitation or driveline disturbance.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a powertrain having an engine selectively mechanically coupled via a friction element to an electric machine; and
a controller programmed to, while operating the powertrain in a hybrid mode and in response to a steering angle greater than a threshold and a decrease in accelerator pedal position, maintain the engine coupling via the friction element to the electric machine and reduce fuel delivery to the engine.

2. The vehicle of claim 1 wherein the controller is further programmed to adjust timing of a camshaft of the engine such that engine braking is inhibited.

3. The vehicle of claim 1 wherein the controller is further programmed to command an engine start in response to an increase in accelerator pedal position.

4. The vehicle of claim 1 wherein the controller is further programmed to operate the electric machine to rotate the engine in response to a transmission input speed being less than a threshold.

5. The vehicle of claim 1 wherein the controller is further programmed to operate the electric machine to maintain a transmission line pressure in response to a transmission line pressure being less than a threshold.

6. The vehicle of claim 3 wherein the powertrain is operated to satisfy a driver demand associated with the increase in accelerator pedal position.

7. The vehicle of claim 3 wherein the engine start comprises an increase in fuel delivery to the engine while a torque carrying capacity of the friction element is increased.

8. A vehicle comprising:
a controller programmed to, in response to a vehicle speed falling below a speed threshold, a decrease in driver demand, and a change in steering position greater than a position threshold, maintain a friction element pressure of a friction element configured to couple an engine with an electric machine, and increase an amount of spark retard associated with an engine cylinder.

9. The vehicle of claim 8 wherein the controller is further programmed to reduce an amount of fuel delivered to the engine cylinder.

10. The vehicle of claim 8 wherein a torque carrying capacity associated with the friction element is reduced while the friction element pressure is maintained.

11. The vehicle of claim 8 wherein the controller is further programmed to modulate at least one of an engine intake valve and an engine exhaust valve to reduce an amount of powertrain torque removed while the amount of spark retard associated with the engine cylinder is increased.

12. The vehicle of claim 8 wherein the controller is further programmed to, in response an increase in driver demand greater than a threshold, decrease an amount of spark retard associated with the engine cylinder, and increase an amount of fuel delivered to the engine cylinder.

13. The vehicle of claim 8 wherein the amount of spark retard associated with the engine cylinder is based on the vehicle speed and a current transmission ratio.

14. The vehicle of claim 12 wherein the controller is further programmed to operate the engine and the electric machine to satisfy the increase in driver demand.

15. A method of controlling a vehicle powertrain comprising:
in response to a decrease in accelerator pedal position and a change in steering angle greater than a threshold angle while a vehicle speed is less than a threshold speed,
deactivating an engine such that an engine crankshaft is permitted to rotate, and
maintaining a friction element pressure such that the engine remains mechanically coupled to an electric machine or a transmission of the powertrain.

16. The method of claim 15 wherein deactivating the engine comprises reducing an amount of fuel delivered to an engine cylinder.

17. The method of claim 15 wherein deactivating the engine comprises increasing an amount of spark retard associated with an engine cylinder.

18. The method of claim 15 further comprising, in response to an increase in accelerator pedal position, activating the engine while maintaining the friction element pressure.

19. The method of claim 18 wherein activating the engine comprises increasing an amount of fuel delivered to an engine cylinder.

20. The method of claim 18 wherein activating the engine comprises decreasing an amount of spark retard associated with an engine cylinder.
